(19) United States
(12) Patent Application Publication
(10) Pub. No.: US 2005/0019738 A1
(43) Pub. Date: Jan. 27, 2005

(54) Educational system

(76) Inventor: Michael Gregory Zelin, Canal Fulton, OH (US)

Correspondence Address: Michael Gregory Zelin, 9555 Beryl Street, Canal Fulton, OH, 44614, US

(21) Appl. No.: 10/894,263

(22) Filed: Jul. 19, 2004

Related U.S. Application Data
(60) Provisional application No. 60/489,297, filed on Jul. 23, 2003.

(51) Int. Cl. G09B 7/00; G09B 3/00

(52) U.S. Cl. 434/323

(57) ABSTRACT

An educational system utilizing emblems, logos, or any other type of insignia, for object oriented learning of innovation, design, business, recycling skills, and history. The system includes each of the following: a first set of educational tutorials including information on principles of solution inventive problems, design, business, recycling, and history of technical and non-technical fields, and didactic materials facilitating learning and practicing said principles, including specific examples, tests, quizzes, and games; a collection of emblems, logos, or any other type of insignia and/or their images arranged in a way facilitating learning said skills; a collection of information related to the said insignia directly, i.e. related to the development of the said insignia, corresponding entity that developed the insignia, or services and products produced by the entity; at least a portion of such information being textual; a collection of information related to the said insignia indirectly, i.e. related to the use of the insignia in educational, entertaining, advertising, collecting, and utility applications, at least a portion of such information being textual; a plurality of samples of products utilizing images or tactile insignia or products manufactured by the entity developed said insignia, and a plurality of means for exhibiting said collections of tactile or images of insignia and related direct and indirect information, including their mounting and storage or delivery by utilizing distance learning technologies, including the Internet and television.

### RELATED APPLICATIONS

This invention is a Continuation-In-Part application claiming priority to co-pending U.S. provisional patent application Ser. No. 60/489,297 filed Jul. 23, 2003 entitled “Method of Recycling of Decorative Automobile Parts”.

### FIELD OF THE INVENTION

The present invention is related to the field of education, and more specifically, to an educational system utilizing emblems, logos, or any other type of insignia, for object oriented learning of innovation, design, business, recycling skills, and history of development of technical and non-technical fields.

### BACKGROUND OF THE INVENTION

There are various educational systems offering training in one or more targeted areas falling in the field of invention. Existing systems can be classified into three major types (FIG. 1).

Type I systems provide learning tutorials. Typically, these tutorials include the following major components: (i) theoretical background, (ii) supporting examples, (iii) practice problems, and (iv) tests. For instance, such systems as TRIZ and ASIT providing training in innovation rely on tutorials teaching users how to invent. These systems utilize a large number of examples, including examples of patented inventions, and use some distance learning technologies, such as the Internet or television.

Type II systems, widely utilized by such organizations as Museums, especially History Museums, more heavily rely on specific objects, which are used not just as examples, but as means of teaching corresponding subject and as objects serving the purpose of attracting user's interest and attention. For instance, Classic Car Museums use automobiles to preserve and illustrate history of automobile development, and Military Museums use military equipment and objects to preserve and illustrate military history. Some of these Museums have collections of emblems, for examples, car emblems or military insignia, including virtual collections posted on the Internet. These collections are used primarily to illustrate historical development of the corresponding fields. Such Object Oriented Learning (OOL) has also been proven as an effective educational approach to teaching various disciplines, especially abstract sciences, such as mathematics or object oriented programming. For example, comprehensive object oriented learning has been used for teaching programming languages heavily relying on use of objects.

Type III systems augment approaches utilized in Type II with those utilized in Type I systems. For instance, there are Science Museums providing educational tutorials on various subjects. In this type of systems, OOL approach is augmented by use of learning courses, some of which utilize modem distance learning technologies.

While existing systems have been widely used for teaching innovation and other important skills and knowledge, they primarily focus on providing theoretical knowledge, even though supported by examples.

One of important limitations of existing systems is related to the fact that they do not provide a system for users to implement learned knowledge and skills.

Still another important limitation of existing systems is related to limited use of didactic means combining deep content with entertaining activities, such as educational games, quizzes, and tests.

Still another important limitation of existing systems, such as Museums (Type II system) is related to the fact that they often require significant monetary resources and maintenance.

Still another important limitation of existing systems is related to the fact that they primarily provide training in one of the target areas.

Present invention provides an educational system of a new type eliminating these limitations of the existing educational systems. This Type IV system augments approaches utilized in Type I system with those used in Type II system with practical implementation techniques as shown schematically in FIG. 1.

### SUMMARY OF THE INVENTION

The present invention provides a new type of educational system utilizing emblems, logos, or any other type of insignia, for object oriented learning of innovation, design, business, recycling skills, and history. Such system has a first set of educational tutorials including information on principles of solution inventive problems, design, business, recycling, and history of technical and non-technical fields, and didactic materials facilitating learning and practicing said principles, including specific examples, tests, quizzes, and games; collection of emblems, logos, or any other type of insignia and/or their images arranged in a way facilitating learning said skills; a collection of information related to the said insignia directly, i.e. related to the development of the said insignia, corresponding entity that developed the insignia, or services and products produced by the entity; at least a portion of such information being textual; a collection of information related to the said insignia indirectly, i.e. related to the use of the insignia in educational, entertaining, advertising, collecting, and utility applications, at least a portion of such information being textual; a plurality of samples of products utilizing images or tactile insignia or products manufactured by the entity developed said insignia, and a plurality of means for exhibiting said collections of tactile or images of insignia and related direct and indirect information, including their mounting and storage or delivery by utilizing distance learning technologies, including the Internet and television.

The usefulness of present invention is related to the fact that it provides a new type of educational system, which is highly efficient in teaching innovation, design, business, recycling skills, and history.

One novel feature of present invention is related to the fact that it provides a new type of educational system.

In contrast to the known educational systems, the present system augments learning of tutorials (Type I learning system) with object oriented learning approach (Type II learning system) utilizing insignia, which is used not only for learning, but also for implementation developed skills. This combination of Type I with Type II learning system providing both system for learning and implementing learned skills differentiates present invention from Type III learning system that simply combines approaches used in Type II and Type I system (FIG. 1).

Another novel feature of present invention is related to the fact that it provides training of several important and interrelated skills, including innovation, design, business, recycling skills, and history of technical and non-technical fields.

Still another novel feature of present invention is related to the fact that tutorials on innovation uniquely combine different approaches to solution of inventive problems with novel tutorials utilizing system analysis of patented common every day inventions and principles of bio-mechanics of martial arts.

Still another novel feature of present invention is related to use of images or tactile insignia in didactic purposes and implementation of learned skills in innovation, design, business, recycling, and history of technical and non-technical fields. Emblems and insignia are popular collection items, and some Museums, including car and military Museums provide insignia collections. In contrast to existing collections, present invention provides solutions in which tactile insignia and insignia images are arranged in collections facilitating learning targeted skills. One of the preferred ways of arranging insignia is organizing collections as Emblems Museums. Emblems are arranged according to related field in Car Emblems Museum, Military Emblems Museum, Sport Emblems Museum, State Emblems Museum, Heraldic Emblems Museum, Professional Emblems Museum, or any other type of Emblems Museum.

Still another novel feature of the present invention is related to use of samples of novel products utilizing both new and used insignia in educational, entertaining, advertising, collecting, and utility applications.

Still another novel feature of the present invention is related to use of novel games and quizzes, both real and virtual, such as computer games and Internet games, utilizing tactile insignia or images of insignia.
Definitions

Distance learning technologies as used herein means movies, television, internet or similar information transmission sources.

### BRIEF DESCRIPTION OF THE DRAWINGS

The invention will be described by way of example and with reference to the accompanying drawings in which:

FIG. 1 shows a schematic diagram illustrating educational systems of different types;

FIG. 2 shows a screenshot of a computer screen illustrating portion of a System Analysis Tutorial on Innovation;

FIG. 3 shows a screenshot of a computer screen illustrating portion of a Tutorial on Bio-Mechanics of Martial Arts;

FIG. 4 shows Cadillac “branch” of General Motors Company's genealogy tree;

FIG. 5 shows a wallet size calendar with the history of Air Force emblem development;

FIG. 6A shows a 2D version of a Tic-Tac-Toe game;

FIG. 6B shows a 3D version of a Tic-Tac-Toe game;

FIG. 7A shows a 2D version of an Emblem game;

FIG. 7B shows a 3D version of an Emblem game;

FIG. 8 shows a version of Bingo game utilizing car emblems;

FIG. 9A shows Cadillac hood emblem utilized as a game piece in a board game;

FIG. 9B shows trivia cards;

FIG. 10 shows a checker utilizing Buick horn button;

FIG. 11 shows playing cards;

FIG. 12 shows a decorative board utilizing Hyundai car emblem and signage attached to a granite board;

FIG. 13A shows a decorative plaque utilizing Mercedes car emblem and image of Mercedes car;

FIG. 13B shows front and back face of a wallet size calendar providing information on Mercedes car emblem development history;

FIG. 14 shows an award item utilizing Mercedes car emblem;

FIGS. 15A and 15B show an embroidery pattern utilizing images of Toyota car emblem and car name plates;

FIG. 16A shows a used Chrysler car emblem utilized as a Christmas ornament;

FIG. 16B shows a Christmas ornament utilizing Buick car emblem as a decorative element;

FIG. 17 shows a gift tag utilizing Oldsmobile car emblem as a decorative element;

FIG. 18 shows a graphical design in a form of the Honda car name plate utilizing image of Honda car emblem;

FIG. 19 shows a portion of the Internet based Car Emblem Museum related to the Pontiac car emblems;

FIG. 20 shows a cup utilizing an Eagle emblem;

FIG. 21A shows a pen/pencil holder utilizing a signage from a used Buick car and decorated by artificial flowers;

FIG. 21B shows a business card holder utilizing Hyundai car signage;

FIG. 21C shows a small item holder utilizing Ford car emblem and decorated by a garland of artificial flowers;

FIG. 21D shows a back of a small item holder utilizing a recycled paper box and decorated by the garland of artificial flowers;

FIG. 22A shows a flowerpot utilizing Ford emblem;

FIG. 22B shows a flowerpot with artificial flowers utilizing Ford emblem;

FIG. 23 shows a slipper utilizing Buick emblem;

FIG. 24A shows a chocolate shaped as a Cadillac emblem;

FIG. 24B shows a wallet size calendar providing information on history of Cadillac emblem development;

FIG. 25A shows a design for a set of chocolates incorporating images of car emblems and decorative elements;

FIG. 25B shows a design for a set of cookies incorporating images of car emblems and decorative elements;

FIG. 26A shows a chocolate with a Cordoba car emblem;

FIG. 26B shows a chocolate element exhibiting an image of an Oldsmobile decorative part used as a component of a baked product; and

FIG. 26C shows a chocolate element exhibiting an image of a Dodge emblem used as a component of a cookie shaped as a classic car.

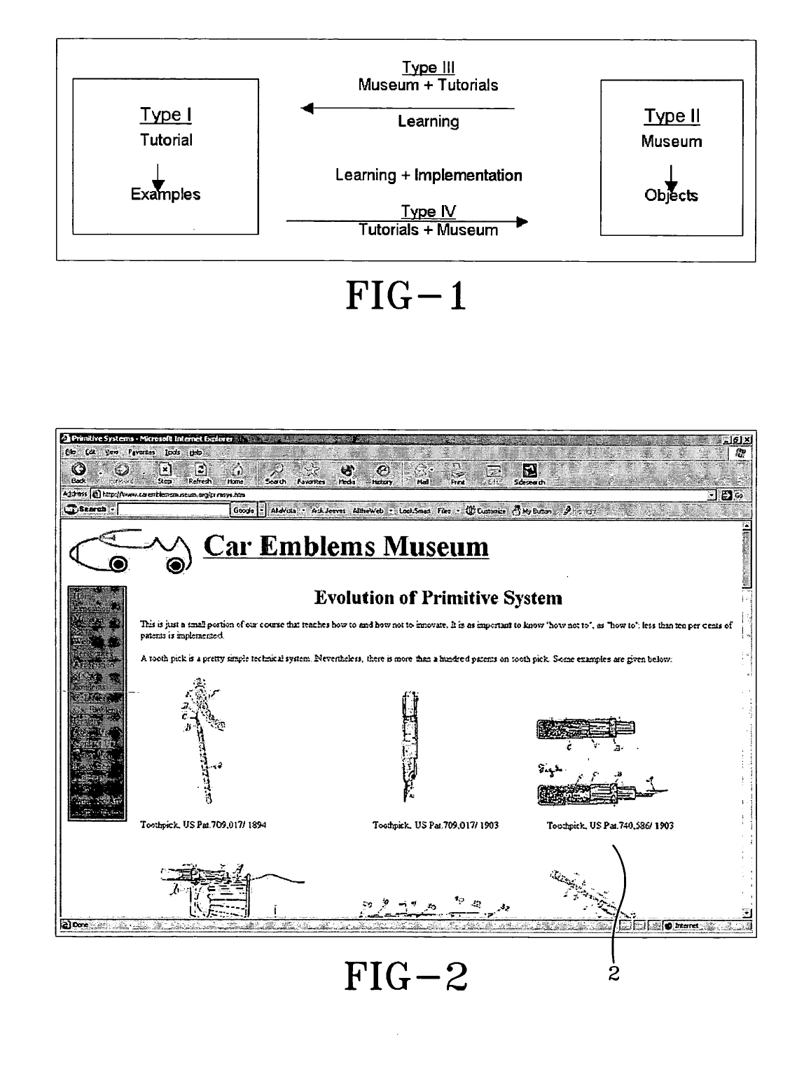

### DETAILED DESCRIPTION OF THE INVENTION

Current invention provides a new type of educational system utilizing emblems, logos, or any other type of insignia, for object oriented learning of innovation, design, business, recycling skills, and history of development of technical and non-technical fields. The system has the following elements and modules as described below.

(1). Set of educational tutorials. Present invention provides tutorials including information on principles of solution inventive problems, design, business, recycling, and history of development of technical and non-technical fields, and didactic materials facilitating learning and practicing said principles, including specific examples, tests, quizzes, and games.

Tutorials on innovation cover different approaches to solution of invention problems. In addition to tutorials on known approaches, current invention provides tutorials on two novel approaches.

System Analysis Approach. According to this approach, technical systems are first classified in classes according to the number of elements, components, and blocks they are comprised of. Then evolution of technical systems is analyzed based on analysis of existing technical solutions. At the next stage, potential directions of future evolution of said technical systems through changes (“mutations”) within the same class or outside same class are defined. At the next step, the most effective changes to the technical system optimizing its functioning are determined. Example 1 of specific implementation provides an example of said system analysis approach. As a part of tutorials developed to help users to learn and use this approach, present invention provides computer programs facilitating analysis of technical systems, evolution, and possible optimized changes.

Analysis of Bio-Mechanics of Martial Arts Approach. Tutorials utilizing this approach consider Martial Arts as an invention invented by people at physical disadvantage (for example, small body size) or any other type of disadvantage (for example, multiple attackers or armed attackers) in order to protect themselves. These tutorials analyze bio-mechanics of different styles of Martial Arts, principles, and techniques. As a part of tutorials developed to help users to learn and use this approach, present inventions provides computer programs facilitating analysis of body mechanics of: strikes by using different parts of body (for example, hand, leg, head) in different variations (for example, open hand, tight fist, edge of the palm) and with various objects (stick, knife, sword) at different parts of opponent's body, including pressure points; throwing techniques (for example, over the hip or shoulder); techniques allowing one to escape from a grip; joint lock techniques; choking techniques and other Martial Art techniques. Example 2 of specific implementation provides an example of said approach.

(2) Collection of images of insignia or tactile insignia. One of the characteristic features of present invention is a wide use of emblems, logos, and other insignia that are used both in tutorials teaching targeted skills and in collections that can be stand alone modules. The insignia and images are arranged in collections facilitating learning targeted skills. One of the preferred ways of arranging insignia is organizing collections as Emblems Museums. Emblems are arranged according to related field in Car Emblems Museum, Military Emblems Museum, Sport Emblems Museum, State Emblems Museum, Heraldic Emblems Museum, Professional Emblems Museum, or any other type of Emblems Museum. These collections can include tactile insignia, images of insignia or a combination of both. Collections of insignia images can be provided to the user in a form of virtual Museums by using video and Internet technologies. To illustrate development of corresponding field or products produced by the corresponding entity, emblems and insignia are arranged to represent “genealogy tree”. Example 3 of specific implementation provides an example of a Cadillac branch of General Motors Company genealogy tree. Images of and tactile insignia can also be arranged to illustrate organizational structure and hierarchy of the corresponding entity or inter relation of products produced by the entity. For instance, military insignia arranged according to the structural hierarchy and type can be used to help users to learn structure of corresponding armed forces. While this type of collection, primarily collections of images of military insignia, exists, they are limited to one country, type of armed force, or specific type of insignia. Present invention provides both collections of various types of tactile insignia and virtual collections of images.

(3) Collection of information related to the said insignia directly. Present invention provides information directly related to the development of the said insignia, corresponding entity that developed the insignia, or services and products produced by the entity. At least a portion of such information is textual. It can also include graphical information, such as images of insignia and products developed by the corresponding entity. Said information can be provided to the user in a printed hard copy form, or electronically, including the Internet, television, and other media. One preferred way to provide such information is in a form of calendars, including wallet, table, or wall size calendars. Example 4 of specific implementation provides an example of a wallet size calendar, which has information on development of Air Force emblem. Another preferred way to deliver said information to users is in a form of computer storage devices, such as compact discs. Still another preferred way to deliver said information to users is through the Internet via links to images of corresponding insignia, games, quizzes, or any other similar means.

(4) Collection of information related to the said insignia indirectly. Present invention provides information indirectly related to the use of the insignia in educational, entertaining, advertising, collecting, and utility applications. At least a portion of such information is textual, and it can include information on design, manufacturing, and distribution of products utilizing insignia in different applications. Said information can also include graphical images of said products and suggested pricing. Present invention also provides a novel methods and means of determining suggested pricing of said products that can be used along with the known methods. According to the said novel method, product price is determined as an average of prices of the Internet auctions on similar items. A computer program incorporated in software package that ensures functioning of the Internet based collections of insignia searches Internet auction sites, determines an average price of similar insignia or products utilizing said insignia, and provides the information on the average price and price range to the user.

(5) Plurality of product samples. Present invention provides a plurality of samples of using knowledge and skills acquired by users at the stage of studying tutorials to development products utilizing images or tactile insignia or products manufactured by the entity developed said insignia. Said products utilize insignia in educational, entertaining, advertising, collecting, and utility applications. Specific examples are described below.

Educational Applications. Present invention provides the following samples of products utilizing insignia in educational purpose.
(i). Coloring books depicting insignia and provide related information;
(ii) Set of cards and set of stickers depicting insignia and provide related information;
(iii). Compact discs providing images of insignia and related information
(iv). Educational games facilitating creativity, enhancing memory, and 3-D thinking.

In one specific implementation of such a game, both 2D and 3D variations of a Tic-Tac-Toe game are provided, which, preferably, utilize images of insignia as detailed in Example 5 of specific implementation. Still in another specific implementation of such a game, both 2D and 3D versions of an “Emblem” game are provided as detailed in Example 6 of specific implementation. Still in another specific implementation of such a game, variation of a Bingo game utilizing insignia images are provided as detailed in Example 7 of specific implementation.

Entertaining Applications. Present invention provides the following samples of products utilizing insignia in educational purpose as described below.
(i). Board Games. In one specific embodiment, car hood emblems are used as game pieces in a game facilitating development of players' business skills. Additionally, trivia cards with information on car development history are used in educational purpose as detailed in Example 8 of specific implementation. In another specific implementation, insignia images are utilized as elements of checkers, chess pieces, or other game pieces used in different games as detailed in Example 9 of specific implementation. In still another embodiment, electronic implementation of said board games stored on a compact disc or on the Internet.
(ii). Card Games. Present invention provides card games utilizing images of insignia as detailed in Example 10 of specific implementation.

Decorative and Advertising Applications. Present invention provides samples of products utilizing insignia in decorative purpose as described below.
(i) Decorative plaque. In one implementation, decorative plaque comprised at least one new or used insignia element, including car emblem, car name plate, or any other decorative automotive part attached to a decorative support, such as a polished wooden board, marble, granite, or any other natural or artificial stone, plastic, cardboard, or any other material as detailed in Example 11 of specific implementation is provided. In still another implementation, a graphical image of the corresponding product, for instance a car or any other related graphical information is provided on the said decorative board utilizing insignia items. In still another implementation, historical information related to the corresponding product and its development history is also provided. This information can include year of manufacturing said product, its technical characteristics, and other pertinent information. It can be provided on the front, back, or any other surface of the plaque. It can also be provided on a separate item combined with the plaques, for instance a wallet size calendar as detailed in Example 12 of specific implementation. In still another implementation, the plaque is a part of a set including information in a digital format, such as a compact disk or a floppy disk. The plaque can be a freestanding item, or it can have means of attaching it to a wall. These means include, but are not limited to hanging wire, magnet, double sticking tape, and other means of securing decorative items on the wall.
(ii) Decorative item or an award item utilizing at least one insignia item as detailed in Example 13 of specific implementation.
(iii) Decorative design formed by combining a plurality of insignia images and an embroidery pattern incorporating insignia items as detailed in Example 14 of specific implementation.
(iv) Decorative product or set of products utilizing insignia as Christmas ornaments. In one specific implementation, means of securing said insignia on the Christmas tree are directly attached to the part items as detailed in Example 15 of specific implementation. In still another specific implementation, insignia item is attached to a typical Christmas ornament, such as a snowflake, a flag, or any other ornament. In still another implementation, insignia item or a set of insignia items is provided in a form of attachments to typical Christmas ornaments.
(v). Gift tag or an element of the gift tag as detailed in Example 16 of specific implementation. In another aspect related to advertising applications, the present invention provides the following example of products.
(vi). Combination of at least one insignia item with elements of graphical design comprised images of the insignia item or textual information as detailed in Example 17 of specific implementation.
(vii). Computer program for producing advertising elements can utilize images of insignia.

Collecting applications. Present invention provides the following samples of products utilizing insignia in collecting purposes as described below.
(i). Set of computer programs for storage of a large database of images and information for electronic implementation of Emblems Museums of images of insignia item and a virtual Internet based Emblems Museums as detailed in Example 18 of specific implementation. In still another implementation, a Web based catalogue with a brief description of the emblem and a price is provided with the price determined as an average price of the Internet based auctions. A special computer program is used to automatically track related auctions and determine an average closing price for similar objects.
(ii) A typical collection item, such as a bell, a collectible glass, a thimble, a cup or a set of these items utilizing decorative automotive parts as detailed in Example 19 of specific implementation.

Utility applications. Present invention provides the following samples of products utilizing insignia in utility purposes as described below.
(i). Paperweight, pen/pencil holder, small items holder, business card holder, or similar items utilizing at least one insignia item as detailed in Example 20 of specific implementation. A small item holder can utilize an insignia item in combination with a garland of artificial flowers. In one specific implementation, the container attached at the back of the insignia item is a paper box, which can be a recycled material. The container can have multiple sections. In still another implementation, the said container is a plastic pocket or a box. The means of securing such items on the vertical surface can include, but are not limited to a double sticking tape, a magnet, or hanging wire.
(ii). Flowerpot utilizing at least one insignia item. In one specific embodiment, at least one insignia item is attached to a frame that serves as flowerpot holder. In still another embodiment, at least one insignia item is permanently attached to the flowerpot as detailed in Example 21 of specific implementation. In still another embodiment, at least one insignia item is used in combination with artificial flowers, a pot holding artificial flowers, or a pot/flowers combination.
(iii). Footwear utilizing at least one insignia item. In one specific embodiment, an insignia item is used as a decorative element of a slipper as detailed in Example 22 of specific implementation in which a Buick decorative part attached to an adjustable band of a slipper. The length of the band can be controlled, and the band can be used to secure child's foot on the top of an adult's foot to tech the child walking skills or as a part of a child-parent activity. In still another embodiment, an insignia item is utilized in a special design slipper with a pocket. Such a pocket can be located on the top, side, or back portion of said slipper, and the said pocket can also have means of closing the pocket, such as a button or zipper.
(iv). Edible products shaped as insignia items or having features of insignia items. In one embodiment, chocolate or any other type of candies are made in a shape of insignia item provided to consumers individually or as a set in combination with historical information on the corresponding insignia item development as detailed in Example 23 of specific implementation. In still another embodiment, chocolate or any other type of confections product having elements of insignia items is an element used as a part or in combination with another confections product, including bakery products, such as donuts, bagels, and cookies. In one specific embodiment, present invention provides a set of inserts in such items as bagels along with pertinent historical information. The set can include inserts made of different materials, i.e. chocolate, mix of nuts and honey, or any other edible product. In still another implementation, chocolate chips, fudge chips, or any other type of edible elements used in chocolate chip cookies or any other type of cookies with chips are shaped in a form of an insignia item. These chips can be used in combination with chips shaped in a form of animals, letters, or any other form. These shaped chips can be used in ice creams or to form a pattern at the surface of the cookie, including image of a corresponding insignia item, or any other shape.

In still another aspect, the present invention provides a method of manufacturing items utilizing new insignia items, used insignia items, a combination of new and used insignia items, or a combination of said insignia items with edible products utilizing images of said insignia items or shaped in a form of said insignia items comprising at least one of the following steps as described below.

Obtaining insignia item, including recovering said used parts from used products Cleaning said items by means of mechanical, chemical, or any other type of cleaning, including removal of any old mounting means if necessary.

Applying new layers of paint, protective translucent coating, fluorescent materials, or any other type of surface coatings improving aesthetic appearance, corrosion or wear protection of said items.

Attaching to the said items fastening means, such as magnetic elements, adhesive tape, or any other types of means of securing said parts on a vertical surface.

Arranging at least one said insignia item on the surface of a product being produced for decorative, educational, advertising, collection, or entertaining purpose and securing said insignia item on the said surface.

Providing related information in a graphical, material, text, digital or any other form.

Combining said insignia items with edible products utilizing images of said insignia items or shaped in a form of said insignia items.

(6) Plurality of means for exhibiting collections of insignia. Current invention provides means for exhibiting collections of insignia and related direct and indirect information, including their mounting and storage or delivery by utilizing distance learning technologies, including the Internet and television. Particularly, present invention provides a set of computer programs for handling large databases of insignia images and delivering them to users via the Internet.

### EXAMPLES OF SPECIFIC IMPLEMENTATION

### Example 1

As an example of tutorial on innovation, FIG. 2 shows a part of the tutorial 2 related to analysis of primitive technical systems.

### Example 2

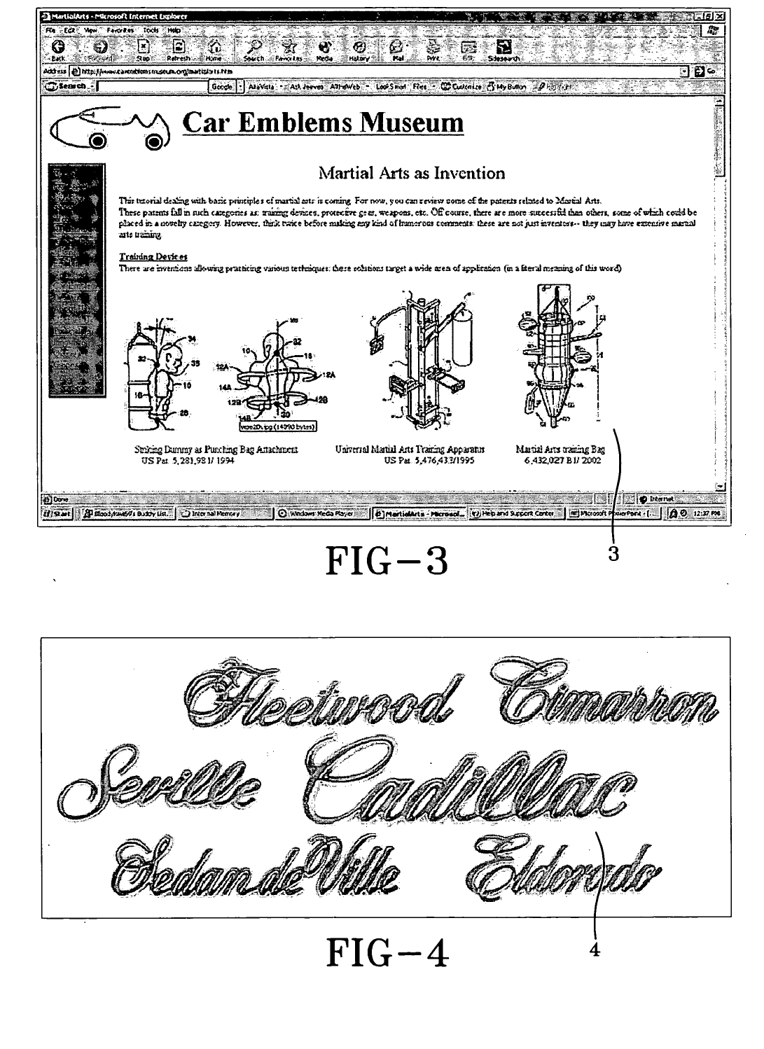

As an example of tutorial on bio-mechanics of Martial Arts, FIG. 3 shows a part of the tutorial 3 dealing with patented inventions related to Martial Arts.

### Example 3

As an example of arranging insignia items/images in a form facilitating learning history of development of corresponding entity or product, FIG. 4 shows an a Cadillac branch 4 of General Motors Company genealogy tree.

### Example 4

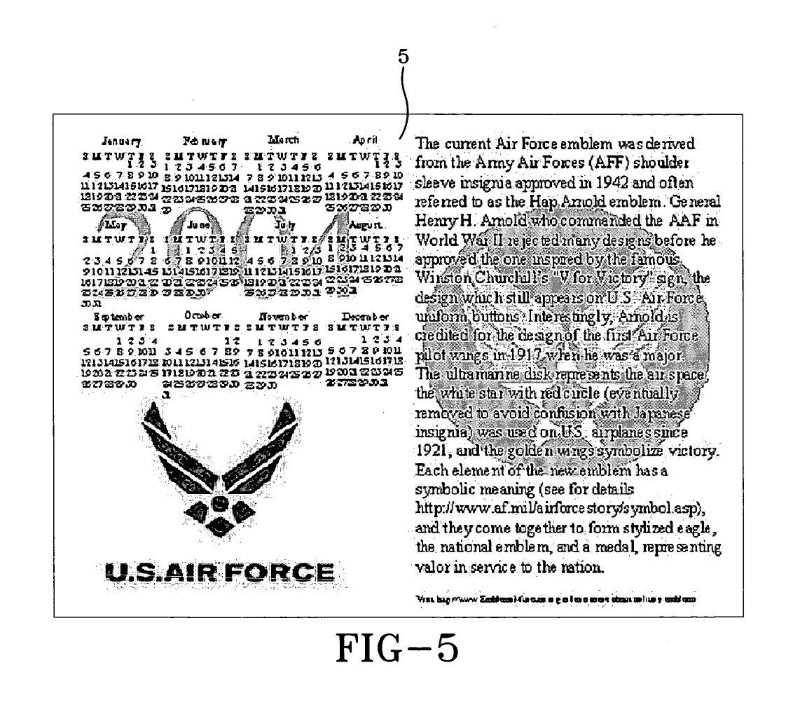

As an example of utilizing insignia and insignia images for delivering information on history of development of corresponding entity or product, FIG. 5 shows an example of a wallet size calendar 5, which has information on development of Air Force emblem.

### Example 5

FIGS. 6A and 6B show screenshots of a computer screen 6 with images of a 2D and 3D implementation of a Tic-Tac-Toe game 7 utilizing images of car emblems 10. Both 2D version and 3D version of the game are played by using two different insignia images. 3D version uses three grids of N×N cells, where N− is a number of cells in a row or column, preferably N=3, representing three sequential layers arranged on the top of each other. As in a 2D implementation, the object of the game is to fill all cells of the grid along one side or along side diagonal, or along cube diagonal. An implementation utilizing tactile insignia is also provided. This version of Tic-Tac-Toe game develops players' ability to concentrate, 3D thinking, and facilitates interest to learning about products developed by the corresponding entity and its history.

### Example 6

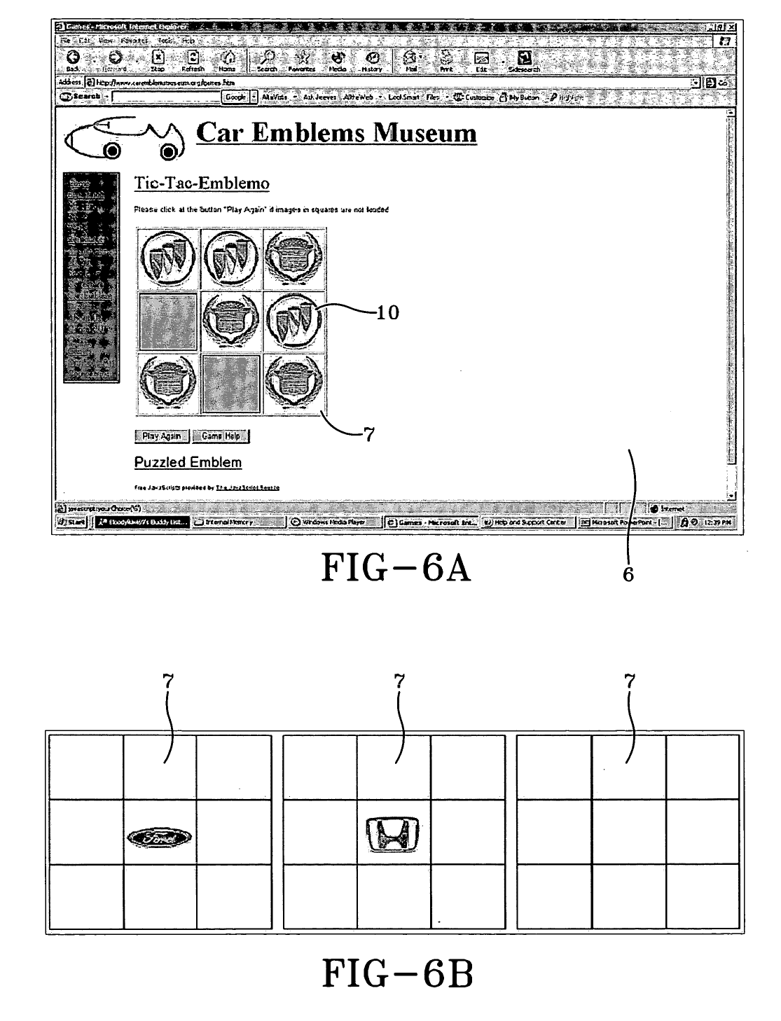

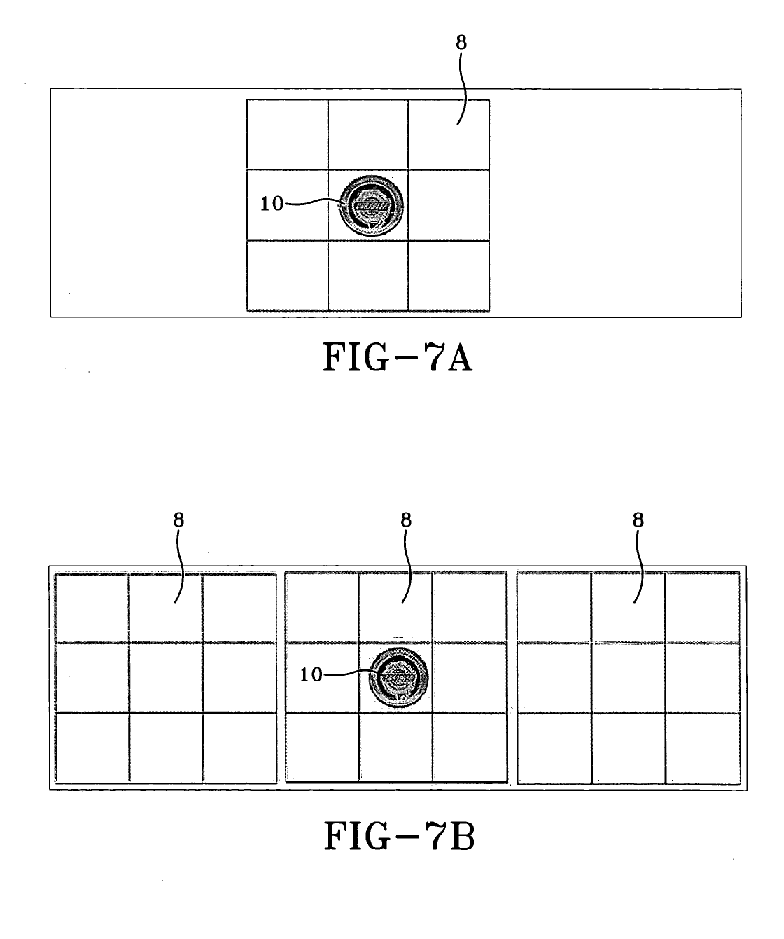

FIGS. 7A and 7B show screenshots of a computer screen 8 with images of a 2D and 3D implementation of an Emblem game utilizing images of car emblems 10. In one implementation, any number of players can participate in the game. It starts with an emblem placed in the center of the grid. Taking turns, players mentally move the emblem horizontally or vertically and between three layers in 3D implementation, but not in the direction opposite to the previous move. A player taking the emblem out of the grid losses, and the game continues until one player left who is the winner. In another implementation, players form two teams. Each team has its own emblem 10 to move mentally. The emblems 10 are placed in corners of the grid. Players of each team can mentally move corresponding emblem horizontally or vertically. Player causing collision of emblems or taking emblem out of the grid loses. This game develops players' ability to concentrate, memory, and 3D thinking.

### Example 7

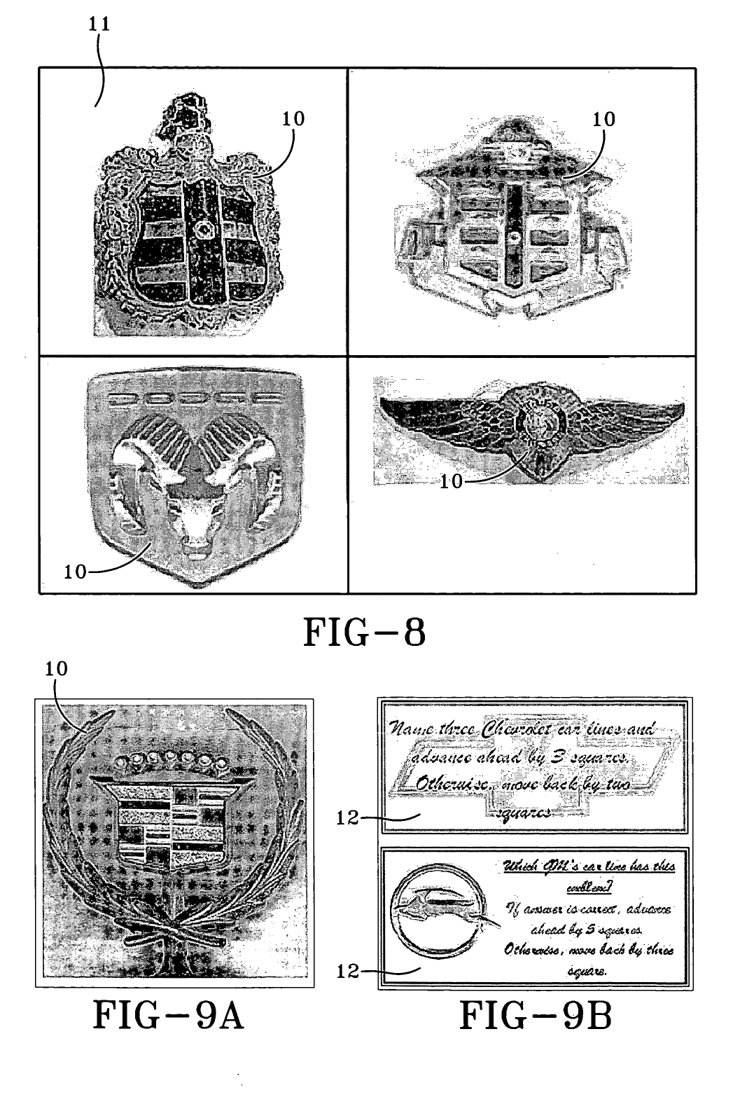

FIG. 8 shows a card used in a BINGO game 11 utilizing car emblems 10 instead of numerals. The game is played according to the standard rules, but insignia elements 10 are used to combine entertainment with education related to the car history development.

### Example 8

FIG. 9A shows car hood emblems 10 used as game pieces in a game facilitating development of players' business skills. The game also uses trivia cards 12 with information on car development history in educational purpose shown in FIG. 9B.

### Example 9

FIG. 10 shows a checker 13 with the Buick emblem 10.

### Example 10

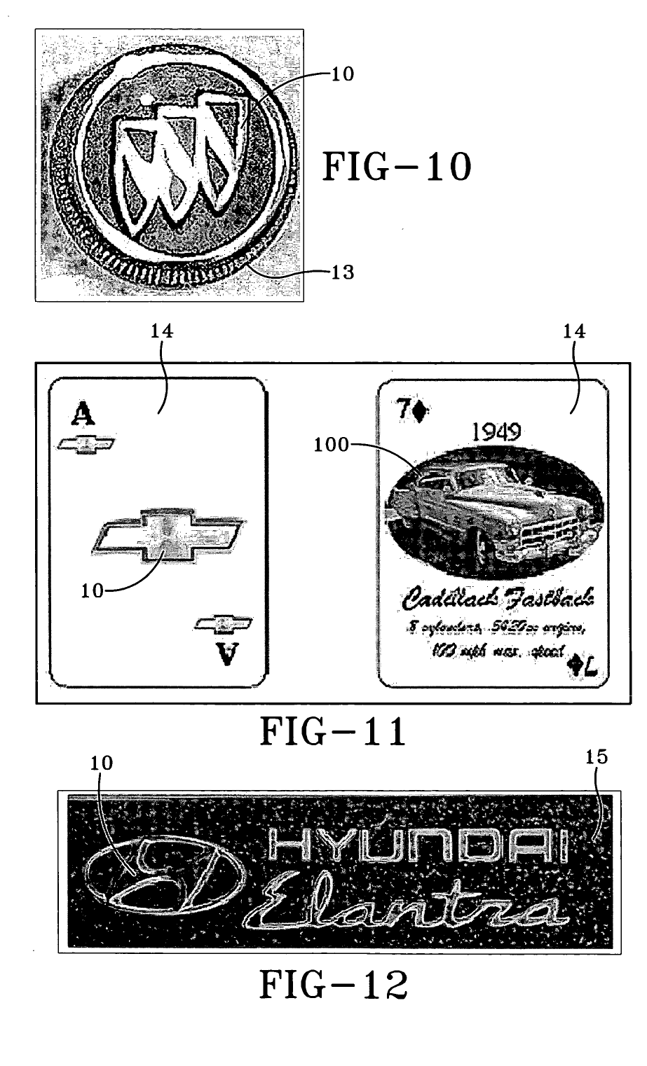

FIG. 11 shows examples of playing cards 14 utilizing car emblems 10 for a card game (Cadillac car emblem 10 is printed at the back of the card showing Cadillac car 100 and related information). The set of cards can come in a box to which a new or re-cycled insignia item is attached.

### Example 11

FIG. 12 shows an example of a decorative board 15 utilizing Hyundai car emblem 10 and signage attached to a granite board by means of a strong adhesive.

### Example 12

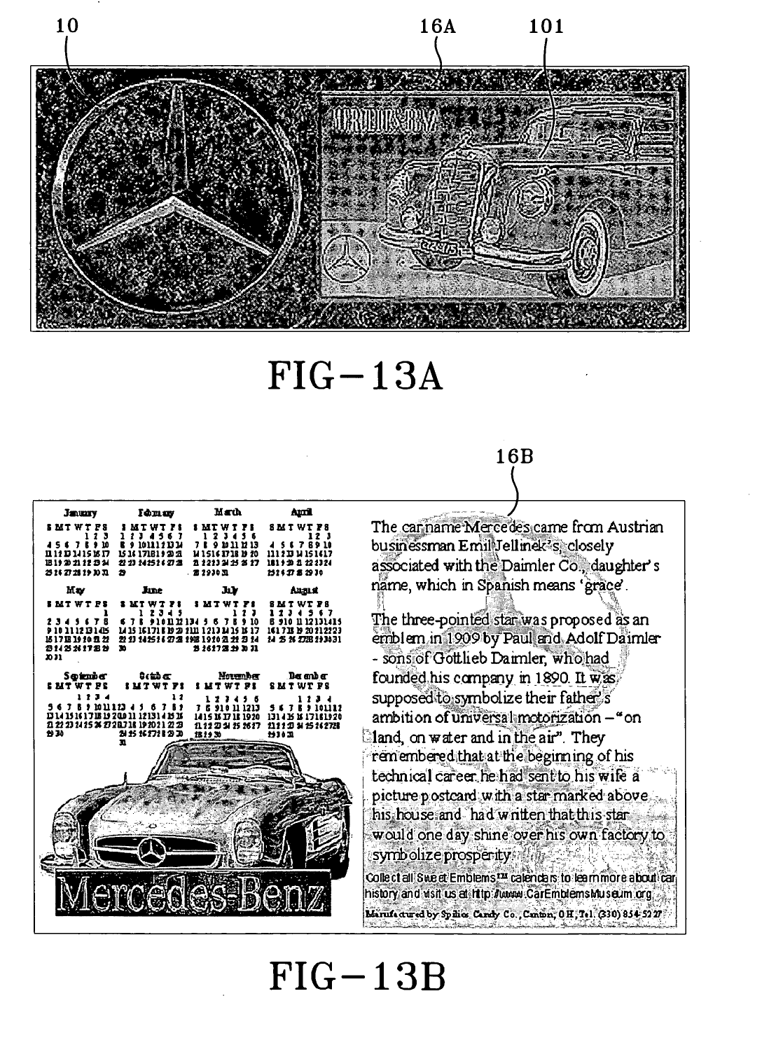

FIG. 13A shows a decorative plaque 16A utilizing Mercedes emblem 10 and a car image 100. FIG. 13B shows a front and a back face of a wallet size calendar 16B with information on Mercedes emblem history.

### Example 13

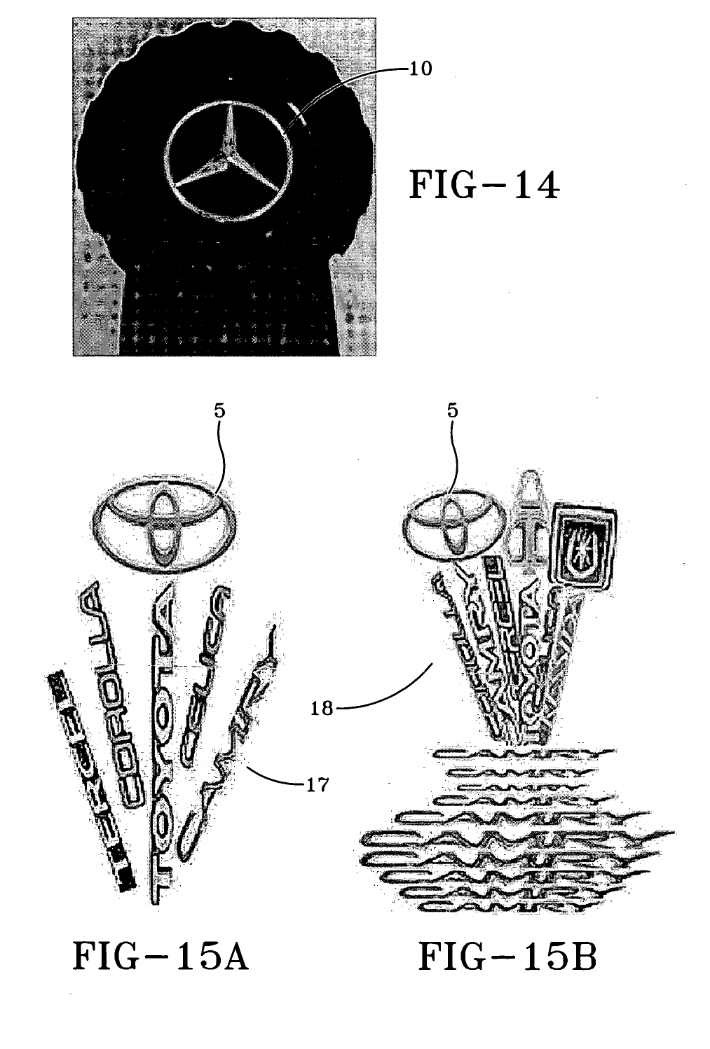

FIG. 14 shows a decorative item utilizing Mercedes emblem 10.

### Example 14

FIGS. 15A and 15B show embroidery patterns 17, 18 respectively comprised of elements of Toyota car names and car emblem 10.

### Example 15

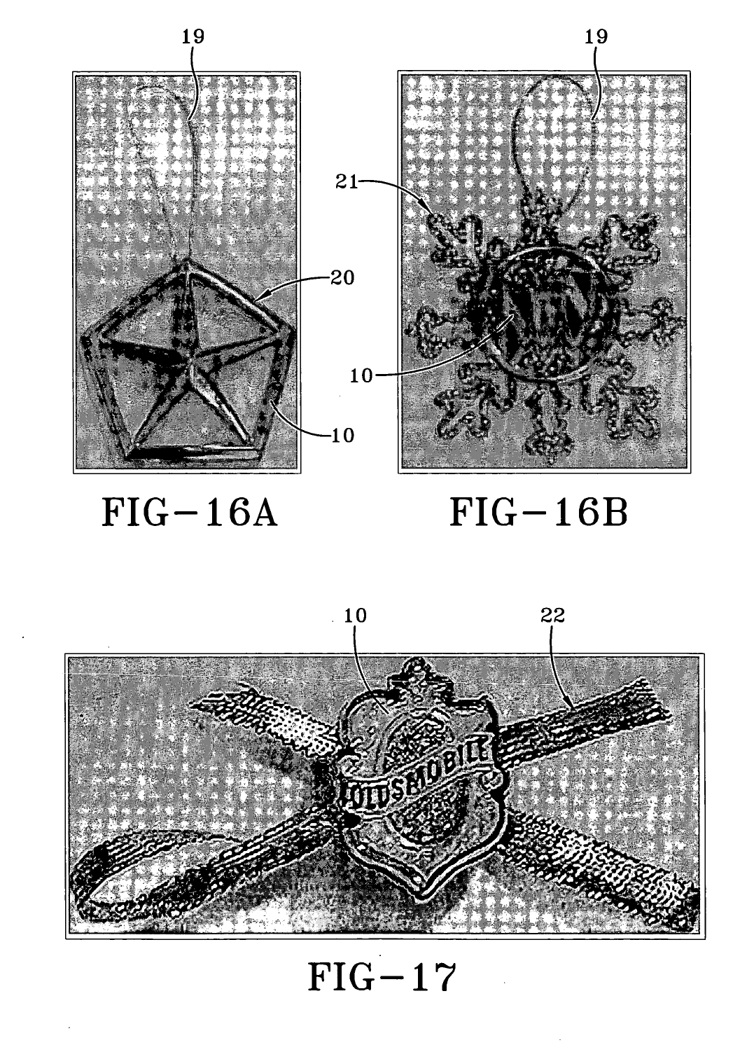

FIG. 16A shows a Dodge car emblem 10 with a string 19 attached for securing the decoration 20 on a Christmas tree, and FIG. 16B shows a Buick decorative part 10 attached to a snowflake Christmas ornament 21.

### Example 16

FIG. 17 shows an Oldsmobile decorative part 10 utilized as an element of a gift tag 22.

### Example 17

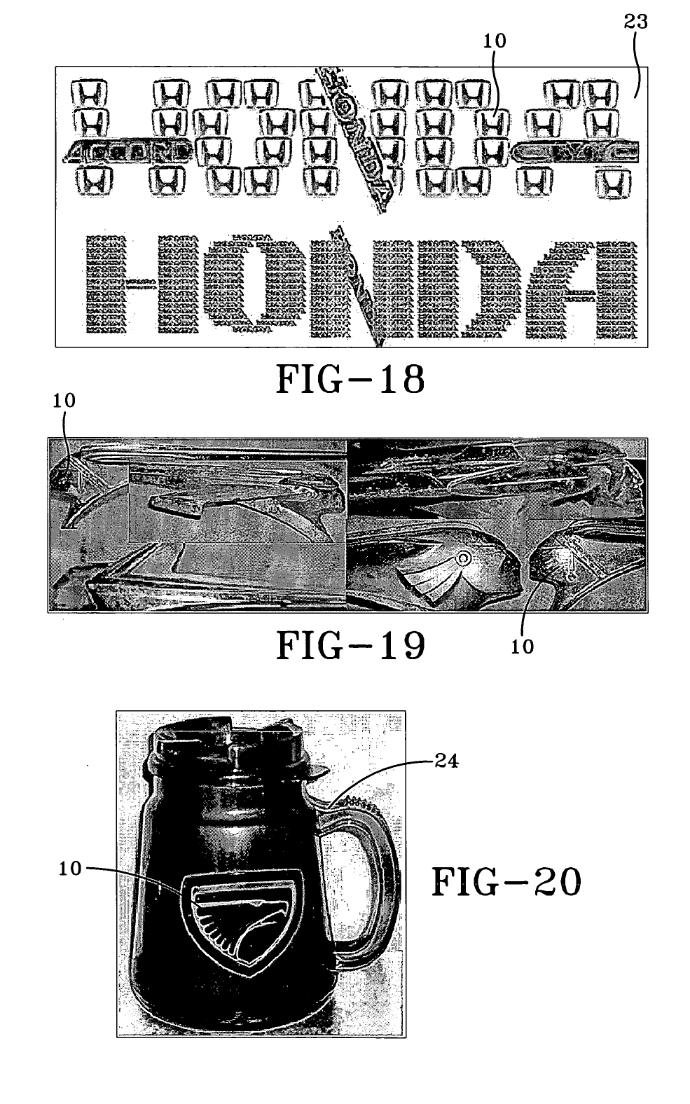

FIG. 18 shows a Honda name plate 23 comprised images of Honda car emblem 10. Such a super-emblem comprised emblems used as graphical unit to produce an image of another insignia item could be used as a garment graphical design or for advertising purpose. This pattern can be designed by using a computer program in which an image of an insignia item is utilized as an individual pixel.

### Example 18

As an example of a virtual Car Emblems Museum, FIG. 19 shows a snapshot of a screen showing a gallery of images of classic car emblems 10 and providing information on the collector or a donor supported the collection.

### Example 19

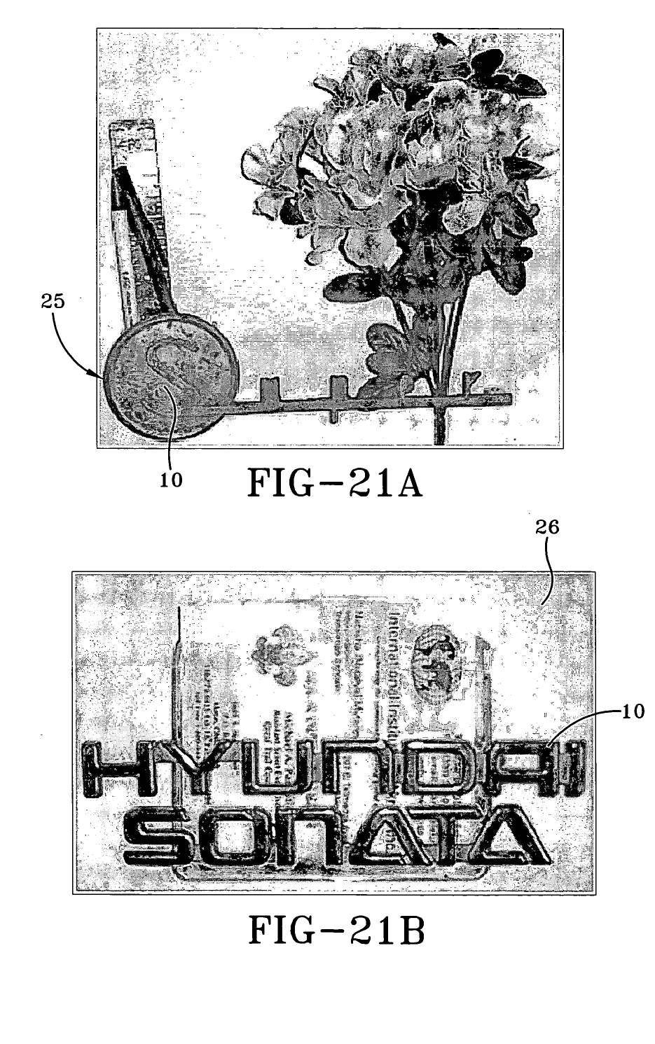

As an example of using insignia items in decorative application, FIG. 20 shows a cup 24 utilizing an Eagle emblem 10. This emblem was recovered from a used vehicle, cleaned, and attached to the cup with a strong adhesive.

### Example 20

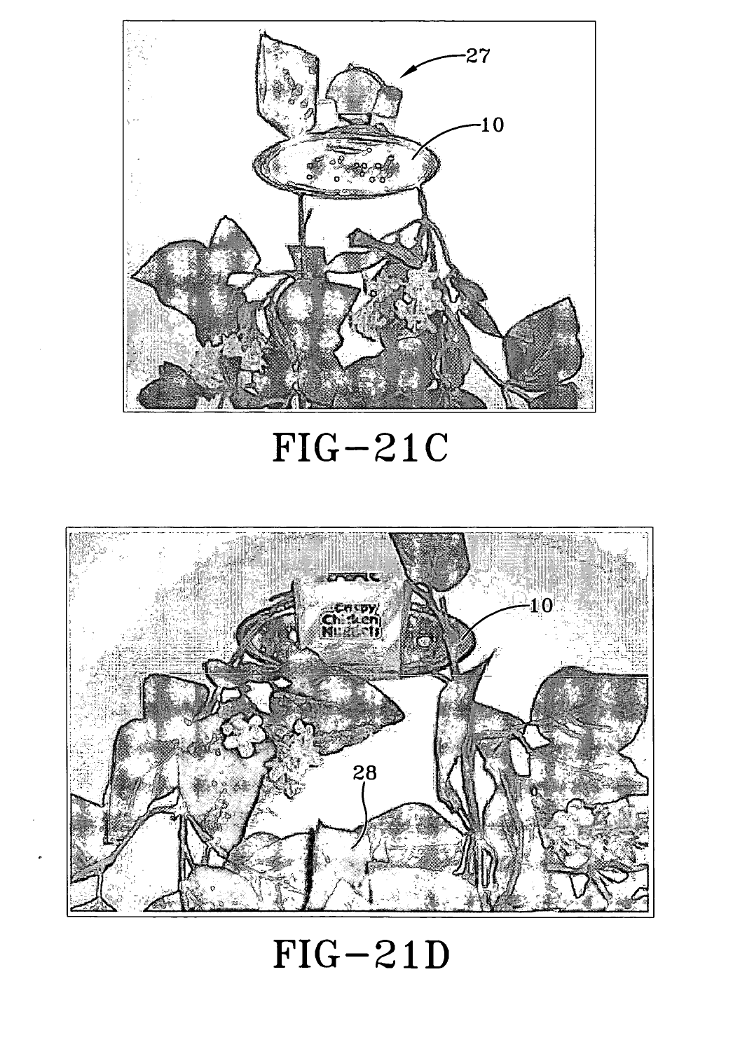

FIG. 21A shows a pen/pencil holder 25 utilizing signage 10 recovered from a Buick car and decorated with artificial flowers, FIG. 21B shows an example of a business card holder 26 utilizing signage 10 recovered from a Hyundai vehicle, and FIG. 21C shows an example of a small item holder 27 utilizing Ford emblem 10 in combination with a garland of artificial flowers. In one specific implementation, the container 28 attached at the back of the decorative automotive part is a paper box, which can be a recycled material (FIG. 21D). The container 28 can have multiple sections. In still another implementation, the said container is a plastic pocket or a box. The means of securing such items on the vertical surface can include, but are not limited to a double sticking tape, a magnet, or hanging wire.

### Example 21

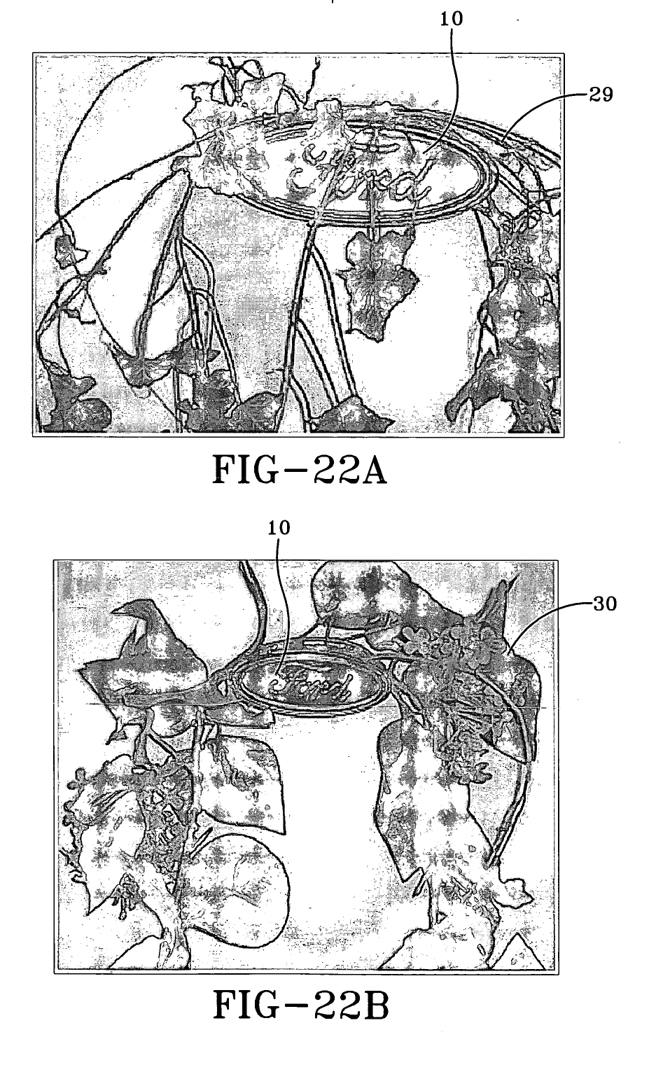

FIG. 22A shows a Ford emblem 10 attached to a flowerpot 29 equipped with a magnetic tape and a strong iron-neodymium magnet at the back and serving as a refrigerator magnet, and FIG. 22B shows a Ford emblem 10 attached to a container 29 holding a plant and artificial flowers 30 as well.

### Example 22

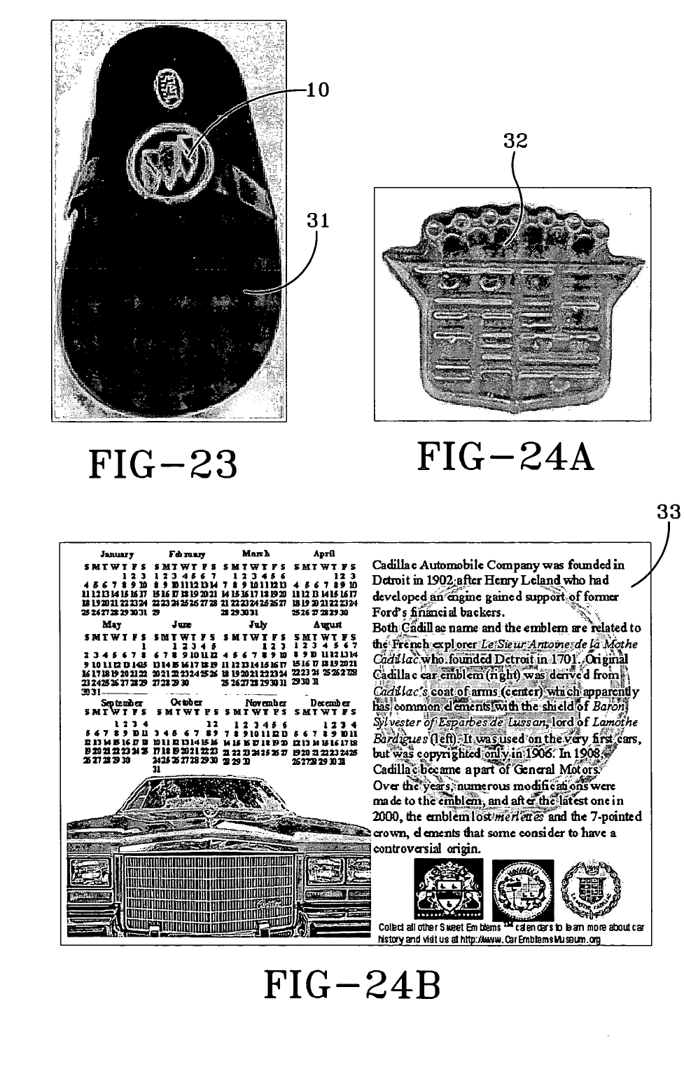

As an example of utility application of insignia items, FIG. 23 shows a slipper 31 with a Buick decorative part 10 attached to an adjustable band of a slipper 31.

### Example 23

As an example, FIG. 24A shows a chocolate candy 32 shaped in a form of a Cadillac emblem and provided as a set with a calendar 33 that has information on history of Cadillac emblem development as shown in FIG. 24B.

### Example 24

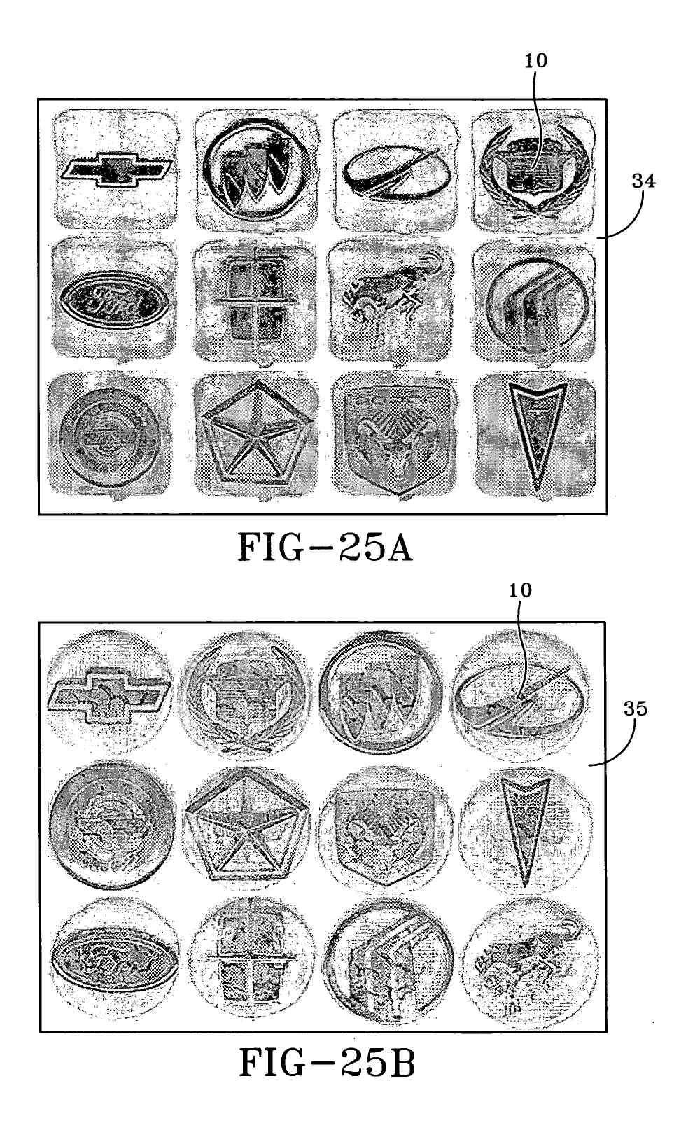

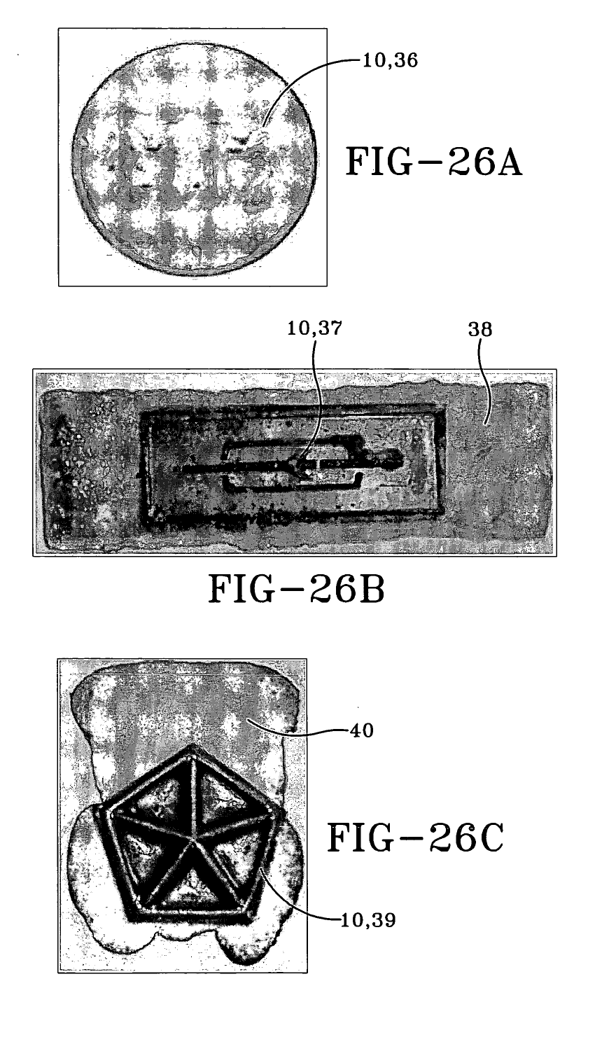

FIG. 25A shows an example of a design for a set 34 of chocolate candies having elements of car emblems 10. FIG. 25B shows a design for a set 35 of cookies incorporating images of car emblems 10. FIG. 26A shows an example of a chocolate element 36 exhibiting Cordoba emblem 10 image. Said element 36 is used as an insert in a donut. FIG. 26B demonstrates a chocolate element 37 exhibiting an image of an Oldsmobile decorative part 10 used as a component of a cookie 38. FIG. 26C shows a chocolate element 39 shaped as a Dodge emblem 10 representing a part of a cookie 40 shaped as a classic car. Such set of inserts can be provided along with pertinent historical information. The set can include inserts made of different materials, i.e. chocolate, mix of nuts and honey, or any other edible product. In still another implementation, chocolate chips, fudge chips, or any other type of edible elements used in chocolate chip cookies or any other type of cookies with chips are shaped in a form of an insignia item. These chips can be used in combination with chips shaped in a form of animals, letters, or any other form. These shaped chips can be used in ice creams or to form a pattern at the surface of the cookie, including image of a corresponding insignia item, or any other shape.

It is further understood that proprietary rights of the emblems and insignias shown herein belong to the manufacturers and that such uses as described herein by way of example, must first receive permission from the owners of those proprietary rights via approved licenses or grants for such uses. The uses as employed herein were solely for describing the best mode of practicing the novel educational system for patent rights acquisition and not for any other commercial exploitation.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. An educational system utilizing emblems, logos, or any other type of insignia, for object oriented learning of innovation, design, business, recycling skills, and history, such system comprising:
a first set of educational tutorials including information on principles of solution inventive problems, design, business, recycling, and history of technical and non-technical fields, and didactic materials facilitating learning and practicing said principles, including specific examples, tests, quizzes, and games;
a collection of emblems, logos, or any other type of insignia and/or their images arranged in a way facilitating learning said skills;
a collection of information related to the said insignia directly, i.e. related to the development of the said insignia, corresponding entity that developed the insignia, or services and products produced by the entity; at least a portion of such information being textual;
a collection of information related to the said insignia indirectly, i.e. related to the use of the insignia in educational, entertaining, advertising, collecting, and utility applications, at least a portion of such information being textual;
a plurality of samples of products utilizing images or tactile insignia or products manufactured by the entity developed said insignia, and
a plurality of means for exhibiting said collections of tactile or images of insignia and related direct and indirect information, including their mounting and storage or delivery by utilizing distance learning technologies, including the Internet and television.

2. The educational system of claim 1, further comprising educational tutorials on innovation tailored to teaching the user elements of inventing on the example of patents on objects of everyday use and utilizing quizzes and games using images or tactile insignia.

3. The educational system of claim 1, further comprising educational games facilitating development of users' 3D thinking abilities, memory, and knowledge of history utilizing images or tactile insignia or products produced by the entity that developed the insignia.

4. The educational system of claim 1, further comprising samples of decorative products utilizing images or tactile insignia, including, but not limited to decorative plaques, refrigerator magnets, decorative bell, and Christmas ornaments.

5. The educational system of claim 1, further comprising samples of edible products utilizing images or tactile insignia provided along with the said edible product, including, but not limited to confectionery products, such as chocolates, candies, and cookies.

6. The educational system of claim 1, further comprising samples of utility products utilizing images or tactile insignia, including, but not limited to paper weight, pen holder, calendar, bookmark, license plate.

7. The educational system of claim 1, further comprising samples of advertising products utilizing images or tactile insignia, including, but not limited to advertising posters.

8. The educational system of claim 1, further comprising Emblems Museums, including, but not limited to Car Emblems Museum, Military Emblems Museum, Sport Emblems Museum, State Emblems Museum, Heraldic Emblems Museum, Professional Emblems Museum, or any other type of Emblems Museum or Gallery exhibiting collection of tactile or images of insignia, and representing an educational module of an Object Oriented Learning system.

9. The educational system of claim 1, further comprising virtual implementation including, but not limited to method of manufacturing products utilizing insignia of claim 3, further comprising at least one of the following steps:
obtaining insignia item, including recovering said used parts from used products;
cleaning said items by means of mechanical, chemical, or any other type of cleaning, including removal of any old mounting means if necessary;
applying new layers of paint, protective translucent coating, fluorescent materials, or any other type of surface coatings improving aesthetic appearance, corrosion or wear protection of said items;
attaching to the said items fastening means, such as magnetic elements, adhesive tape, or any other types of means of securing said parts on a vertical surface.
arranging at least one said insignia item on the surface of a product being produced for decorative, educational, advertising, collection, or entertaining purpose and securing said insignia item on the said surface;
providing related information in a graphical, material, text, digital or any other form; and
combining said insignia items with edible products utilizing images of said insignia items or shaped in a form of said insignia items.
